(19) United States
(12) Patent Application Publication
(10) Pub. No.: US 2017/0153758 A1
(43) Pub. Date: Jun. 1, 2017

(54) TOUCH DISPLAY DEVICE, AND CONTROLLING METHOD AND CIRCUIT THEREOF

(71) Applicants: Shenzhen China Star Optoelectronics Technology Co., Ltd., Shenzhen, Guangdong (CN); Wuhan China Star Optoelectronics Technology Co., Ltd., Wuhan, Hubei (CN)

(72) Inventors: Yucheng Lu, Shenzhen, Guangdong (CN); Chun Hung Huang, Shenzhen, Guangdong (CN); Yao Li Huang, Shenzhen, Guangdong (CN)

(73) Assignees: Shenzhen China Star Optoelectronics Technology CO., Ltd., Shenzhen, Guangdong (CN); Wuhan China Star Optoelectronics Technology, Wuhan, Hubei (CN)

(21) Appl. No.: 14/786,033

(22) PCT Filed: Jun. 18, 2015
(86) PCT No.: PCT/CN2015/081849

§ 371 Date: Dec. 31, 2015

(30) Foreign Application Priority Data
May 26, 2015 (CN) 201510276420.7

(51) Int. Cl. G06F 3/041; G02F 1/133; G02F 1/1368; G02F 1/1362; G06F 3/044; G02F 1/1333

(52) U.S. Cl. CPC G06F 3/0418; G06F 3/0412; G06F 3/044; G02F 1/13338; G02F 1/1368; G02F 1/136286; G02F 1/13306

(57) ABSTRACT

A touch display device, a controlling method, and a circuit thereof are disclosed. During a touch stage, under the control of a control circuit, the TFTs of the touch display device are all turned off, and a same control signal is provided to the data line and the common electrode. The data line and the common electrode always have a same electric potential during the touch stage, and thus the parasite capacitor that is formed by the data line and the common electrode cannot be charged. According to the present disclosure, the influence of the aforesaid parasite capacitor on the touch detection signal can be avoided effectively, and thus the accuracy of the touch detection can be improved.

### CROSS REFERENCE TO RELATED APPLICATION

The present application claims benefit of Chinese patent application CN 201510276420.7, entitled “Touch Display Device, and Controlling Method and Circuit Thereof” and filed on May 26, 2015, the entirety of which is incorporated herein by reference.

### FIELD OF THE INVENTION

The present disclosure relates to the technical field of touch display, and particularly to a touch display device as well as a method and a circuit for controlling the touch display device.

### BACKGROUND OF THE INVENTION

With the popularization of intelligent electronic products, capacitive touch screen has been widely used in mobile phones, tablet personal computers and other electronic products. At present, One Glass Solution (OGS) touch screen, On cell touch screen, and In cell touch screen are commonly used capacitive touch screens. The capacitive touch screen made through In cell technology is thinner and has a better light transmittance because of its advantages in manufacturing technology.

In a liquid crystal display device comprising the In cell touch screen in the prior art, a common electrode is generally controlled in a display and touch time-shared scanning mode. FIG. 1 schematically shows a structure of a common electrode of a liquid crystal display device comprising an In cell touch screen in the prior art. As shown in FIG. 1, the common electrode comprises a plurality of rectangular electrodes 1 that are arranged in an array. Each rectangular electrode 1 is connected with a control circuit 3 through a corresponding addressing line 2. The rectangular electrodes 1 each are controlled by the control circuit 3 in a time-shared manner. Specifically, during a display stage, the rectangular electrodes 1 are driven to an electric potential necessary for the display by the control circuit 3. During a touch stage, the control circuit 3 provides a touch detection signal to the rectangular electrodes 1.

There are at least the following technical defects in the aforesaid liquid crystal display device comprising the In cell touch screen. During the touch stage, the common electrode serves as a touch detection electrode, and a parasite capacitor is easily to be formed between the common electrode and the data line. The parasite capacitor is in series connection with a self-capacitor between the rectangular electrode 1 and the ground, and thus an induced capacitor is reduced. The reduction of the induced capacitor would result in that a driving power of the control circuit 3 is not enough, and thus the control circuit 3 cannot perform normal touch detection.

### SUMMARY OF THE INVENTION

The present disclosure aims to eliminate the technical defect of a liquid crystal display device comprising an In cell touch screen in the prior art. Specifically, during the touch stage, the common electrode serves as a touch detection electrode, and a parasite capacitor is easily to be formed between the common electrode and the data line. The parasite capacitor is in series connection with a self-capacitor between the rectangular electrode and the ground, and thus an induced capacitor is reduced. The reduction of the induced capacitor would result in that a driving power of the control circuit is not enough, and thus the control circuit cannot perform normal touch detection.

In order to solve the aforesaid technical problem, the present disclosure provides a touch display device, as well as a controlling method and a circuit thereof.

According to a first aspect, the present disclosure provides a touch display device, comprising: a common electrode; an array substrate, which is provided with a gate line, a data line, and a Thin Film Transistor (TFT); and a control circuit, which provides a first control signal by which the TFT is turned off to the gate line, a second control signal to the data line, and a third control signal to the common electrode during a touch stage, wherein an amplitude, a frequency, and a phase of the second control signal are the same as an amplitude, a frequency, and a phase of the third control signal respectively.

Preferably, the control circuit further provides a display control signal to the gate line, a pixel voltage signal to the data line, and a common voltage signal to the common electrode during a display stage.

Preferably, the first control signal, the second control signal, or the third control signal is a pulse signal.

According to a second aspect, the present disclosure provides a method for controlling a touch display device, comprising: providing, during a touch stage, a first control signal by which the TFT of the touch display device is turned off to a gate line of the touch display device, a second control signal to a data line of the touch display device, and a third control signal to a common electrode of the touch display device, wherein an amplitude, a frequency, and a phase of the second control signal are the same as an amplitude, a frequency, and a phase of the third control signal respectively.

Preferably, the method further comprises providing a display control signal to the gate line, a pixel voltage signal to the data line, and a common voltage signal to the common electrode during a display stage.

Preferably, the first control signal, the second control signal, or the third control signal is a pulse signal.

According to a third aspect, the present disclosure provides a circuit for controlling a touch display device, comprising: a gate line control module, used for providing a first control signal by which the TFT of the touch display device is turned off to a gate line of the touch display device during a touch stage; a data line control module, used for providing a second control signal to a data line of the touch display device during the touch stage; and a common electrode control module, used for providing a third control signal to a common electrode of the touch display device during the touch stage, wherein an amplitude, a frequency, and a phase of the second control signal are the same as an amplitude, a frequency, and a phase of the third control signal respectively.

Preferably, the gate line control module further provides a display control signal to the gate line during a display stage; the data line control module further provides a pixel voltage signal to the data line during the display stage; and the common electrode control module further provides a common voltage signal to the common electrode during the display stage.

Preferably, the first control signal, the second control signal, or the third control signal is a pulse signal.

Compared with the prior art, one embodiment or a plurality of embodiments according to the present disclosure may have the following advantages or beneficial effects.

In the touch display device according to the present disclosure, during the touch stage, on the one hand, the TFTs of the touch display device are all turned off by the control circuit, and on the other hand, the control circuit provides the same control signal to the data line and the common electrode. The data line and the common electrode always have the same electric potential during the touch stage, and thus the parasite capacitor that is formed by the data line and the common electrode cannot be charged. Therefore, according to the present disclosure, the influence of the parasite capacitor that is formed by the data line and the common electrode on the touch detection signal can be avoided effectively, and thus the accuracy of the touch detection can be improved.

Other features and advantages of the present disclosure will be further explained in the following description, and partially become self-evident therefrom, or be understood through the embodiments of the present disclosure. The objectives and advantages of the present disclosure will be achieved through the structure specifically pointed out in the description, claims, and the accompanying drawings.

### BRIEF DESCRIPTION OF THE DRAWINGS

The accompanying drawings provide further understandings of the present disclosure and constitute one part of the description. The drawings are used for interpreting the present disclosure together with the embodiments, not for limiting the present disclosure. In the drawings:

FIG. 1 schematically shows a structure of a common electrode of a liquid crystal display device comprising an In cell touch screen in the prior art;

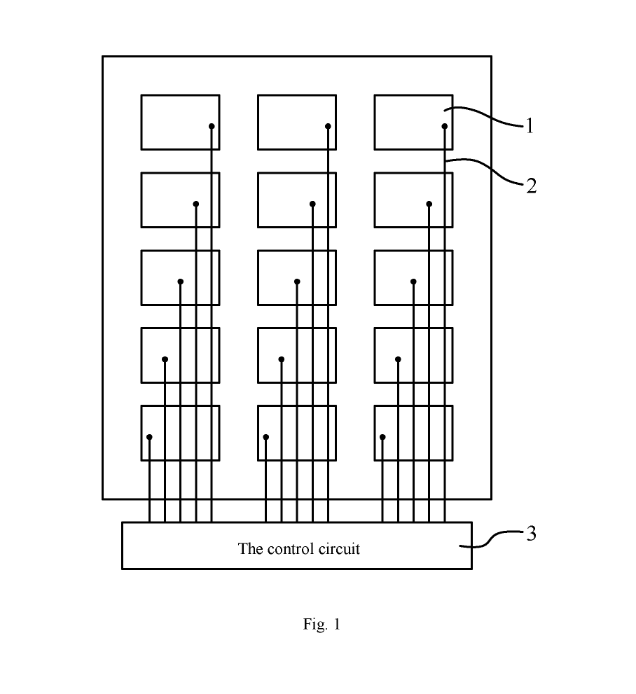

FIG. 2 schematically shows control signals of a touch display device according to an embodiment of the present disclosure;

FIG. 3 is a flow chart of a method for controlling the touch display device according to the embodiment of the present disclosure; and

FIG. 4 schematically shows a structure of a circuit for controlling the touch display device according to the embodiment of the present disclosure.

### DETAILED DESCRIPTION OF THE EMBODIMENTS

The present disclosure will be explained in details with reference to the embodiments and the accompanying drawings, whereby it can be fully understood how to solve the technical problem by the technical means according to the present disclosure and achieve the technical effects thereof, and thus the technical solution according to the present disclosure can be implemented. It should be noted that, as long as there is no structural conflict, all the technical features mentioned in all the embodiments may be combined together in any manner, and the technical solutions obtained in this manner all fall within the scope of the present disclosure.

The present disclosure aims to eliminate the technical defect of a liquid crystal display device comprising an In cell touch screen in the prior art. Specifically, during the touch stage, the common electrode serves as a touch detection electrode, and a parasite capacitor is easily to be formed between the common electrode and the data line. The parasite capacitor is in series connection with a self-capacitor between the rectangular electrode and the ground, and thus an induced capacitor is reduced. The reduction of the induced capacitor would result in that a driving power of the control circuit is not enough, and thus the control circuit cannot perform normal touch detection. In order to solve the aforesaid technical problem, the embodiment of the present disclosure provides a touch display device.

According to the present embodiment, the touch display device comprises a color filter substrate, an array substrate, a common electrode and a control circuit. The array substrate comprises a sub pixel unit array that is divided by a plurality of gate lines and a plurality of data lines, and each sub pixel unit is provided with a TFT and a pixel electrode. The common electrode comprises a plurality of rectangular electrodes that are arranged in an array, and each rectangular electrode is connected with the control circuit through a corresponding addressing line.

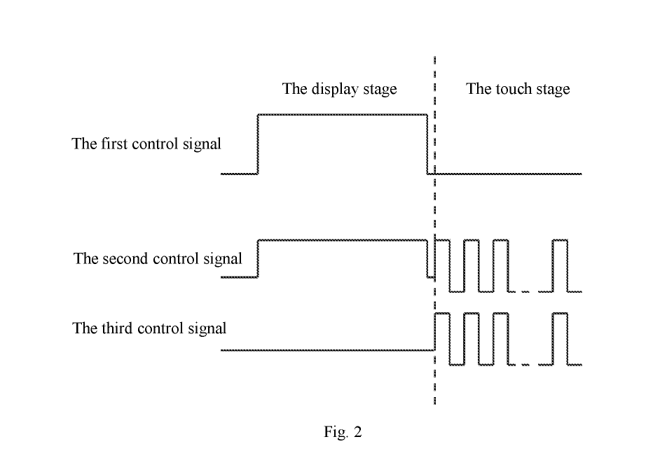

The control circuit is electrically connected with each gate line, each data line, and each rectangular electrode of the touch display device respectively through signal output ends thereof. With respect to a TFT of any sub pixel unit of the touch display device, the control circuit transmits a corresponding control signal to the common electrode and the gate line and the data line that are both connected with the TFT respectively during a touch stage. Specifically, FIG. 2 schematically shows control signals of the touch display device. During the touch stage, the control circuit provides a first control signal to the gate line, a second control signal to the data line, and a third control signal to the common electrode, wherein the first control signal is used for turning off the TFT that is connected with the gate line which receives the signal, and an amplitude, a frequency, and a phase of the second control signal are the same as an amplitude, a frequency, and a phase of the third control signal correspondingly.

It should be noted that, the control circuit provides the third control signal to the common electrode means that the control circuit provides the same third control signal to each of the rectangular electrodes which constitute the common electrode. In this case, the time needed by touch scanning can be reduced, and the time of display scanning can be increased accordingly, which would be favorable for the high resolution display of the touch display device. In addition, there would be no incorrect position reporting, and normal position reporting can be realized when there is mist or water droplet on the screen. Therefore, the position reporting rate, the signal-to-noise ratio and other touch performances can all be improved.

According to the present embodiment, during the touch stage, the voltages of all gate lines are pulled down by the control circuit, and the TFTs corresponding to the gate lines are all turned off. Therefore, during this stage, no matter how the electric potential of the data line changes, the liquid crystal capacitor would not be affected, i.e., the display effect would not be affected. During this stage, the control circuit enables that the amplitude, the frequency, and the phase of the second control signal that is provided to the data line are the same as the amplitude, the frequency, and the phase of the third control signal that is provided to the common electrode correspondingly. It can be seen that, during the touch stage, the second control signal and the third control signal are the same signal. That is, the data line and the common electrode always have the same electric potential during the touch stage, and thus the parasite capacitor that is formed by the data line and the common electrode cannot be charged. Therefore, according to the embodiment of the present disclosure, the influence of the parasite capacitor that is formed by the data line and the common electrode on the touch detection signal can be avoided effectively, and thus the accuracy of the touch detection can be improved.

According to a preferred embodiment of the present disclosure, the control circuit is further used for providing a display control signal to the gate line, a pixel voltage signal to the data line, and a common voltage signal to the common electrode during a display stage. However, the present disclosure is not restricted in this regard. According to other embodiments, the control circuit can only have the function of controlling the touch detection. That is, the control circuit can only play the role of enabling that the parasite capacitor that is formed by the data line and the common electrode cannot be charged during the touch stage.

According to a preferred embodiment of the present disclosure, the first control signal, the second control signal, or the third control signal is a pulse signal, such as a square wave signal, a sine wave signal, or a staircase signal. However, the form of the first control signal, the second control signal, or the third control signal is not restricted to the above according to the present disclosure. That is, the first control signal, the second control signal, and the third control signal can be other signals other than the pulse signal.

Accordingly, the embodiment of the present disclosure further provides a method for controlling the aforesaid touch display device.

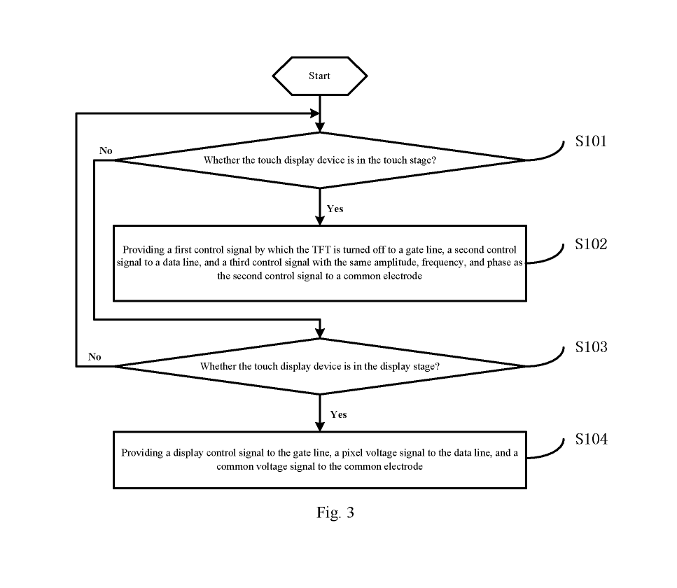

FIG. 3 is a flow chart of a method for controlling the touch display device according to the embodiment of the present disclosure. The controlling method according to the present embodiment mainly comprises step 101 and step 102.

In step 101, whether the touch display device is in the touch stage is determined.

In step 102, when it is determined that the touch display device is in the touch stage, a first control signal by which the TFT of the touch display device is turned off is provided to a gate line of the touch display device, a second control signal is provided to a data line of the touch display device, and a third control signal is provided to a common electrode of the touch display device. The amplitude, the frequency, and the phase of the second control signal are the same as the amplitude, the frequency, and the phase of the third control signal correspondingly.

It should be noted that, the control circuit provides the third control signal to the common electrode means that the control circuit provides the same third control signal to each of the rectangular electrodes which constitute the common electrode. In this case, the time needed by touch scanning can be reduced, and the time of display scanning can be increased accordingly, which would be favorable for the high resolution display of the touch display device. In addition, there would be no incorrect position reporting, and normal position reporting can be realized when there is mist or water droplet on the screen. Therefore, the position reporting rate, the signal-to-noise ratio and other touch performances can all be improved.

In the controlling method according to the present embodiment, when it is determined that the touch display device is in the touch stage, the TFTs corresponding to the gate lines can all be turned off through pulling down the voltage of all the gate lines of the touch display device. Therefore, during the touch stage, the display effect would not be affected no matter how the electric potential of the data line changes. At this time, the second control signal that is provided to the data line can be the same as the third control signal that is provided to the common electrode. Since the data line and the common electrode always have the same electric potential during the touch stage, the parasite capacitor that is formed by the data line and the common electrode cannot be charged. It can be seen that, according to the embodiment of the present disclosure, the influence of the parasite capacitor that is formed by the data line and the common electrode on the touch detection signal can be avoided effectively, and thus the accuracy of the touch detection can be improved.

As shown in FIG. 3, according to a preferred embodiment of the present disclosure, the aforesaid controlling method further comprises step 103 and step 104.

In step 103, whether the touch display device is in the display stage is determined when it is determined that the touch display device is not in the touch stage.

In step 104, when it is determined that the touch display device is in the display stage, a display control signal is provided to the gate line, a pixel voltage signal is provided to the data line, and a common voltage signal is provided to the common electrode.

According to a preferred embodiment of the present disclosure, the first control signal, the second control signal, or the third control signal is a pulse signal, such as a square wave signal, a sine wave signal, or a staircase signal. However, the form of the first control signal, the second control signal, or the third control signal is not restricted to the above according to the present disclosure. That is, the first control signal, the second control signal, and the third control signal can be other signals other than the pulse signal.

Accordingly, the embodiment of the present disclosure further provides a circuit for controlling the aforesaid touch display device.

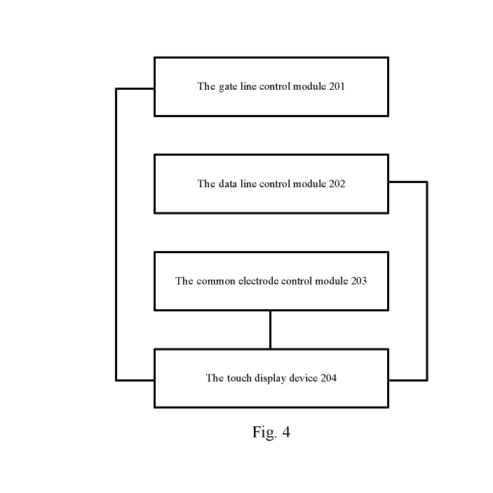

FIG. 4 schematically shows a structure of a circuit for controlling the touch display device according to the embodiment of the present disclosure. The control circuit according to the present embodiment mainly comprises a gate line control module 201, a data line control module 202, and a common electrode control module 203.

Specifically, the gate line control module 201 is electrically connected with the gate lines of the touch display device 204 and used for providing a first control signal by which the TFT of the touch display device 204 is turned off to the gate lines of the touch display device 204 during the touch stage.

The data line control module 202 is electrically connected with the data lines of the touch display device 204 and used for providing a second control signal to the data lines of the touch display device 204 during the touch stage.

The common electrode control module 203 is electrically connected with the common electrode of the touch display device 204 and used for providing a third control signal to the common electrode of the touch display device 204 during the touch stage. It should be noted that, the amplitude, the frequency, and the phase of the second control signal are the same as the amplitude, the frequency, and the phase of the third control signal correspondingly.

It should be noted that, the common electrode control module 203 provides the third control signal to the common electrode means that the common electrode control module 203 provides the same third control signal to each of the rectangular electrodes which constitute the common electrode. In this case, the time needed by touch scanning can be reduced, and the time of display scanning can be increased accordingly, which would be favorable for the high resolution display of the touch display device. In addition, there would be no incorrect position reporting, and normal position reporting can be realized when there is mist or water droplet on the screen. Therefore, the position reporting rate, the signal-to-noise ratio and other touch performances can all be improved.

In the control circuit according to the present embodiment, during the touch stage, the gate line control module 201 pulls down the voltage of all gate lines of the touch display device 204, so that the TFTs corresponding to each gate line can all be turned off. Therefore, during the touch stage, the display effect would not be affected no matter how the electric potential of the data line changes. At this time, the second control signal that is provided to the data line by the data line control module 202 can be the same as the third control signal that is provided to the common electrode by the common electrode control module 203. Since the data line and the common electrode always have the same electric potential during the touch stage, the parasite capacitor that is formed by the data line and the common electrode cannot be charged. It can be seen that, according to the embodiment of the present disclosure, the influence of the parasite capacitor that is formed by the data line and the common electrode on the touch detection signal can be avoided effectively, and thus the accuracy of the touch detection can be improved.

According to a preferred embodiment of the present disclosure, the gate line control module 201 further provides a display control signal to the gate line during the display stage. The data line control module 202 further provides a pixel voltage signal to the data line during the display stage, and the common electrode control module 203 further provides a common voltage signal to the common electrode during the display stage. However, the present disclosure is not restricted in this regard. According to other embodiments, the control circuit can only have the function of controlling the touch detection. That is, the control circuit can only play the role of making that the parasite capacitor that is formed by the data line and the common electrode cannot be charged during the touch stage.

According to a preferred embodiment of the present disclosure, the first control signal, the second control signal, or the third control signal is a pulse signal or a staircase signal. However, the form of the first control signal, the second control signal, or the third control signal is not restricted to the above according to the present disclosure. That is, the first control signal, the second control signal, and the third control signal can be other signals other than the pulse signal.

Apparently, it can be understood by those skilled in the art that, each of the modules and steps of the present disclosure can be realized with a general computing device. They can be centralized in one single computing device, or can be distributed in a network consisting of a plurality of computing devices. Optionally, they can be realized with program codes executable in computing devices, and can thus be stored in storage devices to be executed by the computing devices. Alternatively, they can be made into integrated circuit modules respectively, or a plurality of modules or steps of them can be made into one single integrated circuit module. In this manner, the present disclosure is not limited to any specific combination of hardware and software.

The above embodiments are described only for better understanding, rather than restricting, the present disclosure. Any person skilled in the art can make amendments to the implementing forms or details without departing from the spirit and scope of the present disclosure. The protection scope of the present disclosure shall be determined by the scope as defined in the claims.

1. A touch display device, comprising:
a common electrode;
an array substrate, which is provided with a gate line, a data line, and a TFT; and
a control circuit, which provides a first control signal by which the TFT is turned off to the gate line, a second control signal to the data line, and a third control signal to the common electrode during a touch stage, wherein an amplitude, a frequency, and a phase of the second control signal are the same as an amplitude, a frequency, and a phase of the third control signal respectively.

2. The touch display device according to claim 1, wherein the first control signal, the second control signal, or the third control signal is a pulse signal.

3. The touch display device according to claim 1, wherein the control circuit further provides a display control signal to the gate line, a pixel voltage signal to the data line, and a common voltage signal to the common electrode during a display stage.

4. The touch display device according to claim 3, wherein the first control signal, the second control signal, or the third control signal is a pulse signal.

5. A method for controlling a touch display device, comprising:
providing, during a touch stage, a first control signal by which the TFT of the touch display device is turned off to a gate line of the touch display device, a second control signal to a data line of the touch display device, and a third control signal to a common electrode of the touch display device,
wherein an amplitude, a frequency, and a phase of the second control signal are the same as an amplitude, a frequency, and a phase of the third control signal respectively.

6. The method according to claim 5, wherein the first control signal, the second control signal, or the third control signal is a pulse signal.

7. The method according to claim 5, further comprising providing a display control signal to the gate line, a pixel voltage signal to the data line, and a common voltage signal to the common electrode during a display stage.

8. The method according to claim 7, wherein the first control signal, the second control signal, or the third control signal is a pulse signal.

9. A circuit for controlling a touch display device, comprising:
a gate line control module, used for providing a first control signal by which the TFT of the touch display device is turned off to a gate line of the touch display device during a touch stage;
a data line control module, used for providing a second control signal to a data line of the touch display device during the touch stage; and
a common electrode control module, used for providing a third control signal to a common electrode of the touch display device during the touch stage,
wherein an amplitude, a frequency, and a phase of the second control signal are the same as an amplitude, a frequency, and a phase of the third control signal respectively.

10. The circuit according to claim 9, wherein the first control signal, the second control signal, or the third control signal is a pulse signal.

11. The circuit according to claim 9, wherein:
the gate line control module further provides a display control signal to the gate line during a display stage;
the data line control module further provides a pixel voltage signal to the data line during the display stage; and
the common electrode control module further provides a common voltage signal to the common electrode during the display stage.

12. The circuit according to claim 11, wherein the first control signal, the second control signal, or the third control signal is a pulse signal.
